(19) United States
(12) Patent Application Publication
(10) Pub. No.: US 2008/0297464 A1
(43) Pub. Date: Dec. 4, 2008

(54) DISPLAY DEVICE AND DISPLAY METHOD

(75) Inventor: Ken Ito, Yamato-shi, Kanagawa-ken (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/049,032

(22) Filed: Mar. 14, 2008

(30) Foreign Application Priority Data
May 31, 2007 (JP) 2007146317

(51) Int. Cl. G09G 3/36

(52) U.S. Cl. 345/102

(57) ABSTRACT

A display device includes: a display unit having a first and a second display area displaying a first and a second image corresponding to first and second image data; a light source unit disposed so as to correspond to the display unit and having a plurality of unit light-emitting areas which are independently controllable; a selection unit selecting, from the plural unit light-emitting areas, a first and a second unit light-emitting area corresponding to the first and second display areas respectively; and a control signal generation unit generating a first and a second control signal controlling the selected first and second unit light-emitting areas, based on the first and second image data.

### CROSS-REFERENCE TO RELATED APPLICATIONS

This application is based upon and claims the benefit of priority from the prior Japanese Patent Application No. 2007-146317, filed on May 31, 2007; the entire contents of which are incorporated herein by reference.

### BACKGROUND OF THE INVENTION

1. Field of the Invention

The present invention relates to a display device and a display method.

2. Description of the Related Art

There has been disclosed an art relating to a liquid crystal display device with improved image quality of a display screen on which both a moving image and a still image exist (see, for example, JP-A 2005-99367 (KOKAI)). Specifically, four separate backlights are arranged in a scanning direction of a liquid crystal panel, one frame of a video input signal is divided into four frame blocks corresponding to these four backlights, and it is determined whether each of the frame blocks is a moving image or a still image. Then, the backlight corresponding to the frame block determined as the moving image is turned on and off and the backlight corresponding to the frame block determined as the still image is kept turned on. Therefore, there occurs less afterimage phenomena and edge blurs in the moving image and there occurs no flicker in the still image.

### BRIEF SUMMARY OF THE INVENTION

A display device sometimes displays different images on a plurality of display areas which are appropriately set on the display device. In this case, a user can set and change the plural display areas as desired. A possible method in this case is to divide and control backlights according to the contents displayed on the plural display areas. However, in the afore the prior art, how the backlights are divided is fixed.

It is an object of the present invention to provide a display device and a display method in which light sources can be appropriately divided and controlled according to display areas.

A display device according to an aspect of the present invention includes: a display unit having a first and a second display area displaying a first and a second image corresponding to first and second image data respectively; a light source unit disposed so as to correspond to the display unit and having a plurality of unit light-emitting areas which are independently controllable; a selection unit selecting, from the plural unit light-emitting areas, a first and a second unit light-emitting area corresponding to the first and second display areas respectively; and a control signal generation unit generating a first and a second control signal controlling the selected first and second unit light-emitting areas, based on the first and second image data.

A display method according to another aspect of the present invention is an image display method in a display device which includes: a display unit having a first and a second display area displaying a first and a second image corresponding to first and second image data respectively; and a light source unit disposed so as to correspond to the display unit and having a plurality of unit light-emitting areas which are independently controllable, the method including: selecting, from the plural unit light-emitting areas, a first and a second unit light-emitting area corresponding to the first and second display areas respectively; and generating a first and a second control signal controlling the selected first and second unit light-emitting areas, based on the first and second image data.

### BRIEF DESCRIPTION OF THE DRAWINGS

FIG. 1 is block diagram showing the structure of a liquid crystal display device 100.

FIG. 2 is a schematic view showing an example of a state where a first and a second display area A1, A2 are set.

FIG. 3 is a schematic view showing an example of a state where a first and a second display area A1, A2 are set.

FIG. 4 is a schematic view showing an example of a state where a first to a fourth display area A1 to A4 are set.

FIG. 5 is a schematic chart showing an example of the contents stored in an area information memory 180.

FIG. 6 is a schematic chart showing an example of the contents stored in the area information memory 180.

FIG. 7 is a block diagram showing the structure of a liquid crystal display device 200.

FIG. 8 is a block diagram showing the structure of a liquid crystal display device 300.

FIG. 9 is a block diagram showing the structure of a liquid crystal display device 400.

FIG. 10 is a block diagram showing the structure of a liquid crystal display device 500.

### DETAILED DESCRIPTION OF THE INVENTION

### First Embodiment

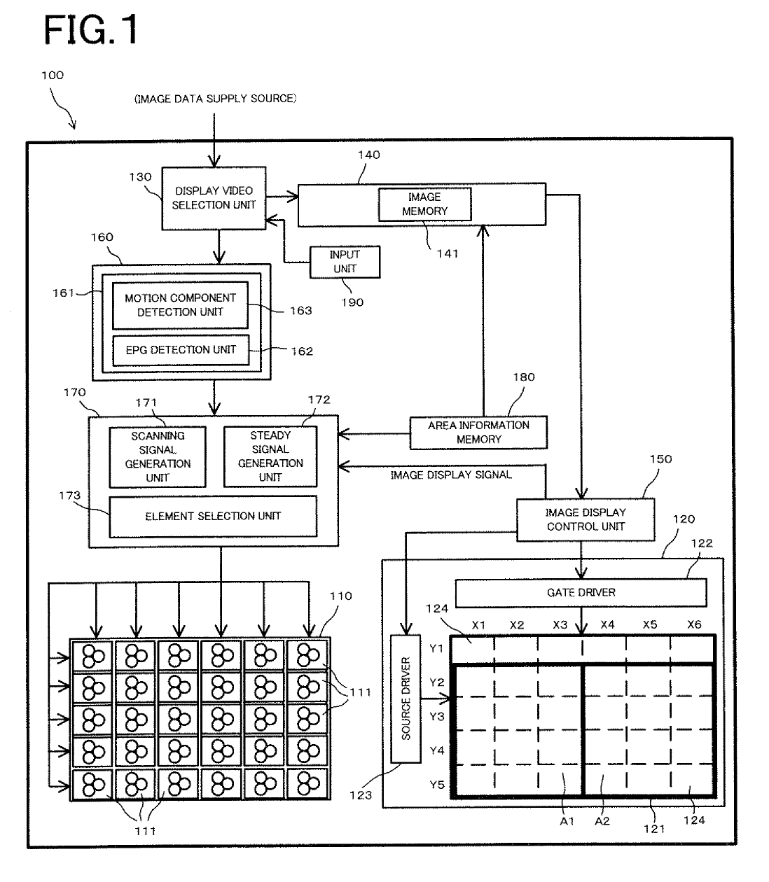

Hereinafter, a liquid crystal display device 100 according to a first embodiment of the present invention will be described in detail with reference to the drawings. FIG. 1 is a block diagram showing the structure of the liquid crystal display device 100. As shown in FIG. 1, the liquid crystal display device 100 includes a backlight unit 110, a display unit 120, a display video selection unit 130, a video signal synthesis unit 140, an image display control unit 150, a light source control instruction unit 160, a backlight control unit 170, an area information memory 180, and an input unit 190.

The backlight unit 110 is disposed behind the display unit 120, in particular, behind a later-described liquid crystal panel 121 and has a plurality of unit light sources 111.

The unit light sources 111 are arranged in matrix and function as unit light-emitting areas whose light emissions are independently controllable by the backlight control unit 170. As will be described later, a plurality areas 124 corresponding to the respective unit light sources 111 can be set on the liquid crystal panel 121. That is, emission intensities on the backlight unit 110 corresponding to the respective plural areas 124 can be independently controlled. Each of the unit light sources 111 has a plurality of LEDs (Light Emitting Diodes) emitting lights in different colors (for example, red (R), green (G), and blue (B)). The lights from the RGB LEDs, when mixed, can produce white light. Further, it is possible to change a color temperature of each of the unit light sources 111 by controlling a ratio of emission intensities of RGB.

A pair of diffusion plates and a prism sheet sandwiched by the diffusion plates, though not shown, are provided between the backlight unit 110 and the liquid crystal panel 121. The diffusion plates scatter and diffuse the lights supplied by the backlight unit 110 to prevent uneven brightness at boundaries of the unit light sources 111. The prism sheet is intended for enhancing brightness of the lights supplied from the backlight unit 110.

It should be noted that the unit light sources 111 forming the backlight unit 111 are not limited to the LEDs but various light-emitting elements can be used. Examples of the light-emitting element are an organic EL (Electro Luminescence) element, an inorganic EL element, and a laser diode.

The display unit 120 essentially consists of the liquid crystal panel 121, a gate driver 122, and a source driver 123.

Two sheets of glass on which scanning lines and data lines are disposed respectively and a liquid crystal material sandwiched between the sheets of glass, though not shown, form the liquid crystal panel 121. The scanning lines and the data lines intersect with each other and are driven by the gate driver 122 and the source driver 123. By the gate driver 122 and the source driver 123 applying voltages to the liquid crystal, an image is displayed on the liquid crystal panel 121. Intersections of the scanning lines and the data lines correspond to pixels. In order to display a color image on the liquid crystal panel 121, the R, G, and B colors are made to develop at each of the pixels.

The gate driver 122 sequentially outputs a pulsed voltage waveform to the scanning lines. The source driver 123 outputs a pulsed voltage waveform to a signal line in response to the output of the pulsed voltage waveform from the gate driver 122.

Since the backlight unit 110 is disposed so as to correspond to the liquid crystal panel 121, the plural areas 124 corresponding to the respective unit light sources 111 can be set on the liquid crystal panel 121. Boundaries of the areas 124 correspond to the boundaries of the unit light sources 111. Here, in order to identify the areas 124, coordinates X1 to X6 are assigned in an X direction of the areas 124 and coordinates Y1 to Y5 are assigned in a Y direction. For example, the upper left area 124 can be expressed by the coordinates (X1, Y1) and the lower right area 124 can be expressed by the coordinates (X6, Y5). The coordinates (Xi, Yj) identify the unit light sources 111 as well as identifying the areas 124 on the liquid crystal panel 121. That is, the coordinates (Xi, Yj) are information specifying both the areas 124 and the unit light sources 111. Appropriately selecting some of the areas 124 makes it possible to set a plurality of display areas Ai on the liquid crystal panel 121 to display different images on the display areas Ai.

Here, as a first and a second display area A1, A2, (X1, Y2)-(X3, Y5) and (X4, Y2)-(X6, Y5) are set. “(Xi, Yj)-(Xk, Yl)” can define a display area A whose diagonal extends from the area 124 expressed by the coordinates (Xi, Yj) to the area 124 expressed by the coordinates (Xk, Yl). As will be described later, the information “(Xi, Yj)-(Xk, Yl)” defining a range of the display area A is stored in the area information memory 180, and signals are synthesized by the video signal synthesis unit 140 based on this information, and an image is displayed on each of the display areas Ai.

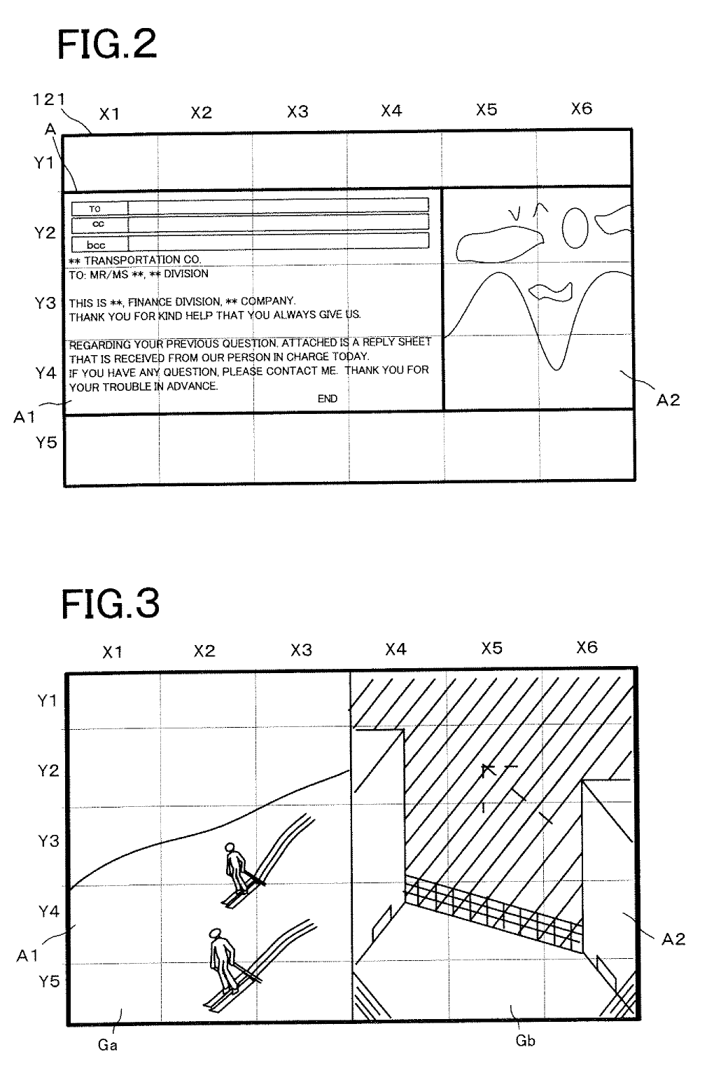

FIG. 2 and FIG. 3 are schematic views showing examples of a state where the first and second display areas A1, A2 are set on the liquid crystal panel 121.

In FIG. 2, (X1, Y2)-(X4, Y4) and (X5, Y2)-(X6, Y4) are set as the first and second display areas A1, A2. Here, the second display area A2 is smaller than the first display area A1. A still image (mail transmission/reception window) and a moving image (TV image) are displayed on the display areas A1, A2 respectively. As will be described later, the unit light sources 111 corresponding to the display area A1 turn on and off and those corresponding to the display area A2 are kept turned on.

In FIG. 3, (X1, Y1)-(X3, Y5) and (X4, Y1)-(X6, Y5) are set as the first and second display areas A1, A2. Here, the first display area A1 and the second display area A2 have the same size. A moving image (DVD image) and a moving image (TV image) are displayed on the display areas A1, A2 respectively. In this case, the unit light sources 111 corresponding to the display area A1 and the unit light sources 111 corresponding to the display area A2 both turn on and off.

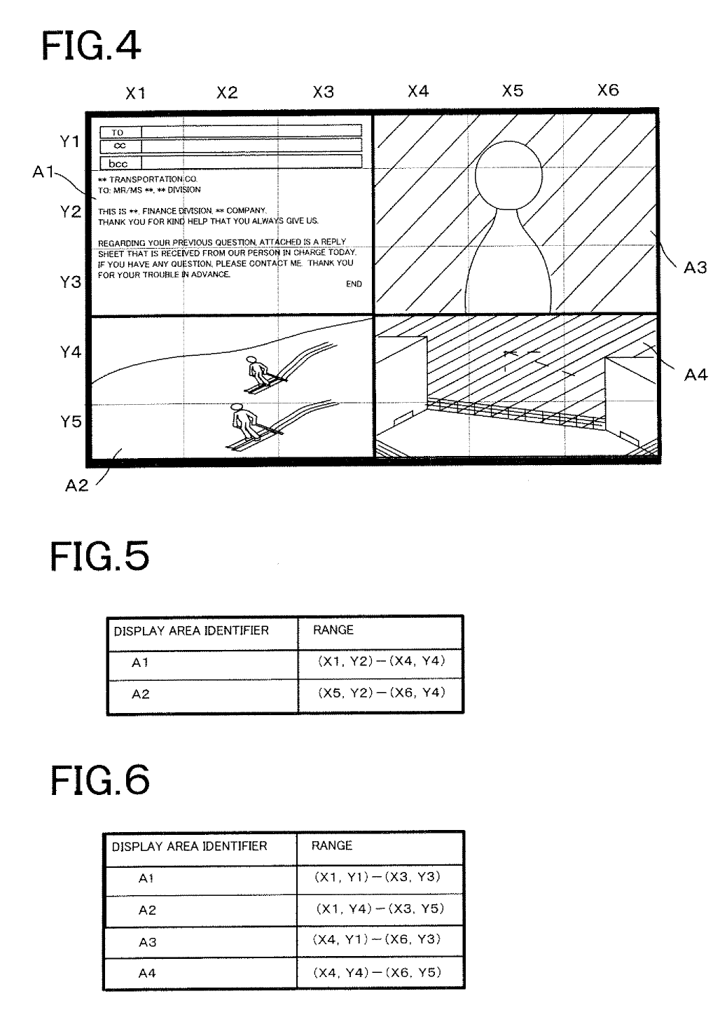

FIG. 4 is a modified example of the display areas on the liquid crystal panel 121. Specifically, FIG. 4 is a schematic view showing an example of a state where a first to a fourth display area A1 to A4 are set on the liquid crystal panel 121. In this manner, a display area on the liquid crystal panel 121 can be divided into a large number of the display areas. In FIG. 4, (X1, Y1)-(X3, Y3), (X1, Y4)-(X3, Y5), (X4, Y1)-(X6, Y3), and (X4, Y4)-(X6, Y5) are set as the first to fourth display areas A1 to A4. Here, a still image (mail transmission/reception window) is displayed on the display area A1, a moving image (DVD image) on the display area A2, a moving image (interphone image) on the display area A3, and a moving image (TV image) on the display area A4. In this case, the unit light sources 111 corresponding to the display area A1 are kept turned on. The unit light sources 111 corresponding to the display areas A2 to A4 turn on and off.

The display video selection unit 130 receives a plurality of image data from an external part of the liquid crystal display device 100 and outputs image data selected from the received image data. For example, TV image data and image data from a personal computer (hereinafter, referred to as PC) can be selected as the first and second image data respectively. The display video selection unit 130 can change the image data to be selected according to selection information input from the input unit 190. For example, the reception of the TV image data is changed to the reception of the image data from the PC.

The display video selection unit 130 receives image signals (image data) from, for example, an antenna, externally connected apparatuses (for example, an HD-DVD player, an HD-DVD recorder, a DVD player, a DVD recorder, an interphone, a PC, and so on), and a local area network (hereinafter, referred to as “LAN”). Examples of the video signal from the antenna are various image data carried by a terrestrial analog wave, a terrestrial digital wave, a satellite broadcast radio wave, and the like.

The “image data” is composed of, for example, R, G, B pixel data. The R, G, B pixel data correspond to the pixel of the liquid crystal panel 121. The pixel data has a luminance value as information indicating brightness of the corresponding pixel. An Electronic Program Guide (hereinafter, referred as EPG) is appended to some image data. The EPG includes category information of the image data (information indicating “movie”, “music”, “variety show”, or the like).

The image signal synthesis unit 140 combines the plural images corresponding to the respective plural image data output from the display video selection unit 130, into one image. The video signal synthesis unit 140 has an image memory 141 corresponding to the composite image. Specifically, the plural image data are written to different addresses on the image memory 141 respectively. The image data is written to an address corresponding to the information “(Xi, Yj)-(Xk, Yl)” indicating the range of the display area A stored in the area information memory 180.

At this time, if the sizes of the proper display ranges of the received first and second image data are different from the sizes of the first and second display areas A1, A2, the image signal synthesis unit 140 applies scaling to the first and second image data so as to make the first and second image data displayable on the display areas A1, A2. The same applies to the case where the display areas are A1 to A4. The “scaling” means the magnification of image data smaller than the display areas A1, A2 and reduction of image data larger than the display areas A1, A2.

The image display control unit 150 receives the display image data output from the image signal synthesis unit 140 to make the display unit 120 display the image. The image display control unit 150 sends an image display signal to the backlight control unit 170 when making the display unit 120 display the image. This image display signal is intended for synchronizing a lighting operation of the backlight unit 110 with the display of the image on the display unit 120.

The light source control instruction unit 160 has a moving image/still image determination unit 161. The moving image/still image determination unit 161 determines whether each of the image data output from the display video selection unit 130 is a moving image or a still image and has an EPG detection unit 162 and a motion component detection unit 163.

The EPG detection unit 162 detects whether or not the EPG is appended to the input first and second image data.

As for the first or second image data which is determined as not including the EPG by the EPG detection unit 162, the motion component detection unit 163 detects whether this image data includes a motion component (motion vector). The motion vector is a vector representing a motion from a reference frame (image corresponding to a given instant of a moving image) when the image is a moving image. Based on the comparison of frames, the motion vector is extracted. Concretely, a frame is divided into blocks, and a relative position of a block with the smallest difference from the preceding frame is the motion vector. Further, the motion vector can be easily extracted from many image signals (for example MPEG2), since they include information on the motion vector because of image compression.

When the EPG detection unit 162 detects the EPG in an image data or the motion component detection unit 163 detects the motion vector in the image data, the moving image/still image determination unit 161 determines that this image data is image data of a moving image. Further, when neither the EPG nor the motion vector is detected in the image data, the moving image/still image determination unit 161 determines that this image data is image data of a still image. Then, the moving image/still image determination unit 161 outputs the determination result.

The backlight control unit 170 controls the unit light sources 111 corresponding to each of the display areas Ai, based on the image type determination result output from the light source control instruction unit 160 and the area information.

The backlight control unit 170 has a scanning signal generation unit 171, a steady signal generation unit 172, and an element selection unit 173.

The scanning signal generation unit 171 generates a scanning signal for turning on and off the unit light sources 111. By turning on and off the unit light sources 111 in synchronization with frames of the moving image (backlight scanning), a blur of the moving image is solved. Since the operating speed of the liquid crystal panel 121 is not necessarily high, there is a possibility that an image different from an original image may be displayed at the start of the frame of the moving image and this may be recognized as a blur of the moving image. By turning off the unit light sources 111 at the initial stage of a frame change and turning on the unit light sources 111 after the completion of the frame change, the blur of the moving image is solved.

The steady signal generation unit 172 generates a steady signal for keeping the unit light sources 111 turned on. When a still image is displayed, the unit light sources 111 are kept turned on. This is because the backlight scanning for a still image causes the occurrence of a flicker of screen display (flicker phenomenon).

The element selection unit 173 outputs the scanning signal or the steady signal to the unit light sources 111 corresponding to each of the display areas A1, A2 stored in the area information memory 180 and functions as a selection unit selecting a first and a second unit light-emitting area from a plurality of light-emitting areas.

The area information memory 180 stores pieces of the information “(Xi, Yj)-(Xk, Yl)” indicating the ranges of the display areas Ai.

FIG. 5 and FIG. 6 are schematic charts showing examples of the contents stored in the area information memory 180. Identifiers of the display areas Ai and the ranges “(Xi, Yj)-(Xk, Yl)” of the display areas are shown in correspondence to each other. In these examples, the stored contents in FIG. 5 correspond to the display example in FIG. 2 and the stored contents in FIG. 6 correspond to the display example in FIG. 4.

The input unit 190 is, for example, a touch panel, a press button group, a keyboard, or the like. The input unit 190 may be a receiver (for example, an infrared receiver) receiving a command from a not-shown remote controller having buttons equivalent to any of the above. The input unit 190 inputs, to the display video selection unit 130, information instructing a change of connected apparatuses from which the first and second image data are received.

As described above, according to the liquid crystal display device 100 of this embodiment, the unit light sources 111 can be controlled according images to be displayed on the display areas A1, A2 of the display unit 120. Further, it is determined whether or not an image to be displayed on each of the first and second display areas A1, A2 is a moving image or a still image, and based on the determination result, it is possible to appropriately change a lighting way of the unit light sources 111 corresponding to the display areas A1, A2. This can prevent a flicker and a blur of a moving image ascribable to an image difference.

### Second Embodiment

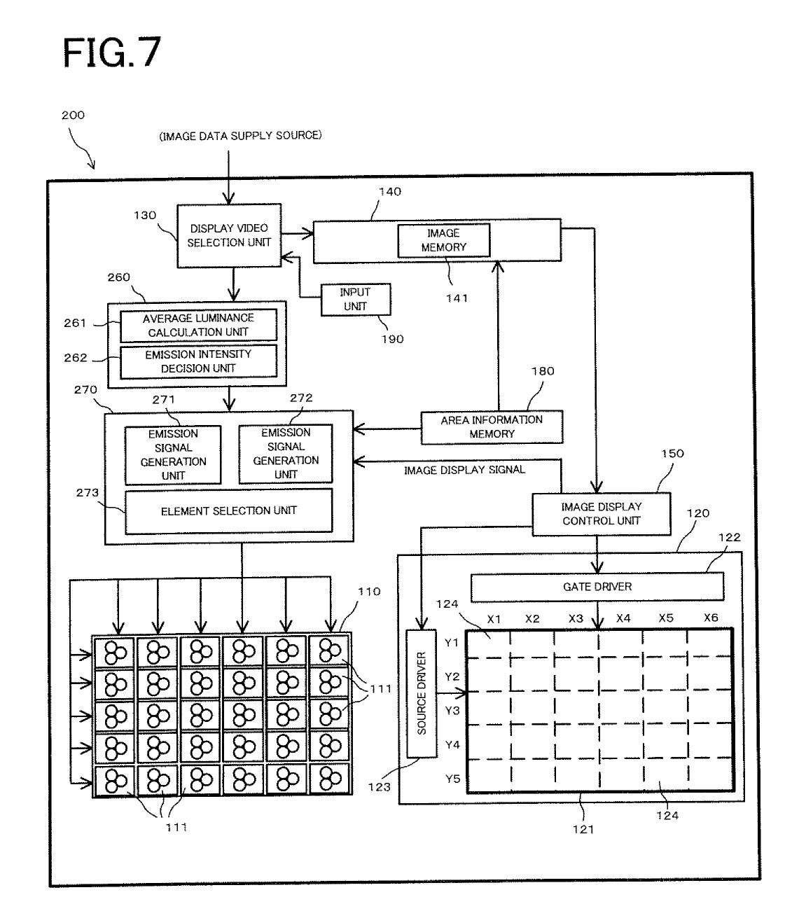

Hereinafter, a liquid crystal display device 200 according to a second embodiment of the present invention will be described in detail with reference to the drawing. FIG. 7 is a block diagram showing the structure of the liquid crystal display device 200. As shown in FIG. 7, the liquid crystal display device 200 has a backlight unit 110, a display unit 120, a display video selection unit 130, a video signal synthesis unit 140, an image display control unit 150, a light source control instruction unit 260, a backlight control unit 270, an area information memory 180, and an input unit 190.

The light source control instruction unit 260 has an average luminance calculation unit 261 and an emission intensity decision unit 262. The average luminance calculation unit 261 calculates an average luminance of each display area Ai. The emission intensity decision unit 262 decides an emission intensity of unit light sources 111 corresponding to each of the display areas Ai, based on the average luminance calculated by the average luminance calculation unit 261. When the calculated average luminance is lower than a predetermined reference luminance, the emission intensity is made higher than a reference emission intensity. For example, depending on whether the calculated average luminance is higher or lower than the predetermined reference luminance, different coefficients are adopted (when the average luminance is higher than the reference: a small coefficient, when the average luminance is lower than the reference: a large coefficient), and the emission intensity decision unit 262 multiplies the average luminance by a correction value, thereby calculating the emission intensity. This is to prevent so-called blackening.

When an image that is bright as a whole (that is, an image whose whole luminance on the screen is high) and an image that is dark as a whole (that is, an image whose whole luminance on the screen is low) are simultaneously displayed, a dark screen becomes difficult to see (blackening). As shown in FIG. 3 described above, a skiing image Ga from DVD and a movie image Gb from TV are displayed on the first and second display areas A1, A2 respectively of the display unit 120. The image Ga is bright as a whole, in other words, it is an image whose pixel data have a high luminance as a whole. The image Gb is dark as a whole, in other words, it is an image whose pixel data have a low luminance as a whole. At this time, the unit light sources 111 corresponding to the skiing image Ga are lighted so as to achieve a high luminance, which sometimes causes blackening of the movie image Gb.

The backlight control unit 270 has emission signal generation units 271, 272 and an element selection unit 273. The emission signal generation units 271, 272 output control signals Si controlling emission intensities of the unit light sources 111 in the respective display areas Ai, based on the decision by the emission intensity decision unit 262. The element selection unit 273 outputs the control signals Si to the unit light sources 111 corresponding to the respective display areas Ai stored in the area information memory 180.

### Third Embodiment

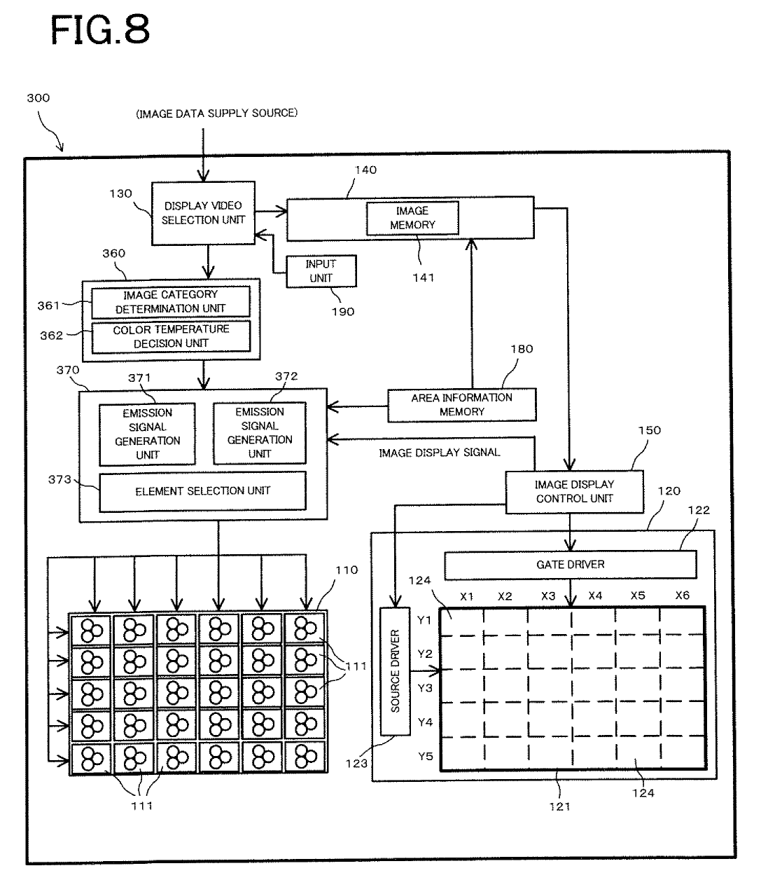

Hereinafter, a third embodiment of the present invention will be described in detail with reference to the drawing. FIG. 8 is a block diagram showing the structure of a liquid crystal display device 300 according to the third embodiment of the present invention. As shown in FIG. 8, the liquid crystal display device 300 includes a backlight unit 110, a display unit 120, a display video selection unit 130, a video signal synthesis unit 140, an image display control unit 150, a light source control instruction unit 360, a backlight control unit 370, an area information memory 180, and an input unit 190.

The light source control instruction unit 360 has an image category determination unit 361 and a color temperature decision unit 362.

The image category determination unit 361 determines a category of an image which is to be displayed on each display area Ai. For example, it is possible to determine the category as “movie”, “variety show”, or “drama” by using EPG.

The color temperature decision unit 362 decides a color temperature of unit light sources 111 in each of the display areas Ai, based on the determination result of the image category determination unit 361. For example, if the category is “movie”, the color temperature is set low (for example, 5000 Kelvin to 6000 Kelvin), if the category is “variety show”, the color temperature is set high (10,000 Kelvin), and if the category is “drama”, the color temperature is set to an average value (8000 Kelvin). It is possible to decide the color temperature by using a table showing category information and color temperature in correspondence to each other.

The backlight control unit 370 has emission signal generation units 371, 372 and an element selection unit 373. Based on the decision by the color temperature decision unit 362, the emission signal generation units 371, 372 output control signals Si controlling emission intensities of the unit light sources 111 in the respective display areas A1, A2. The element selection unit 373 outputs the control signals Si to the unit light sources 111 corresponding to the respective display areas Ai stored in the area information memory 180. By thus controlling the color temperature based on the category information stored in the EPG, it is possible to reduce blackening without any luminance correction. The adjustment of the luminance by a correction value without using the color temperature sometimes affects a response speed of image display of the display unit 120, which may make an image seem unnatural, but controlling the color temperature to prevent the blackening can solve this problem.

### Fourth Embodiment

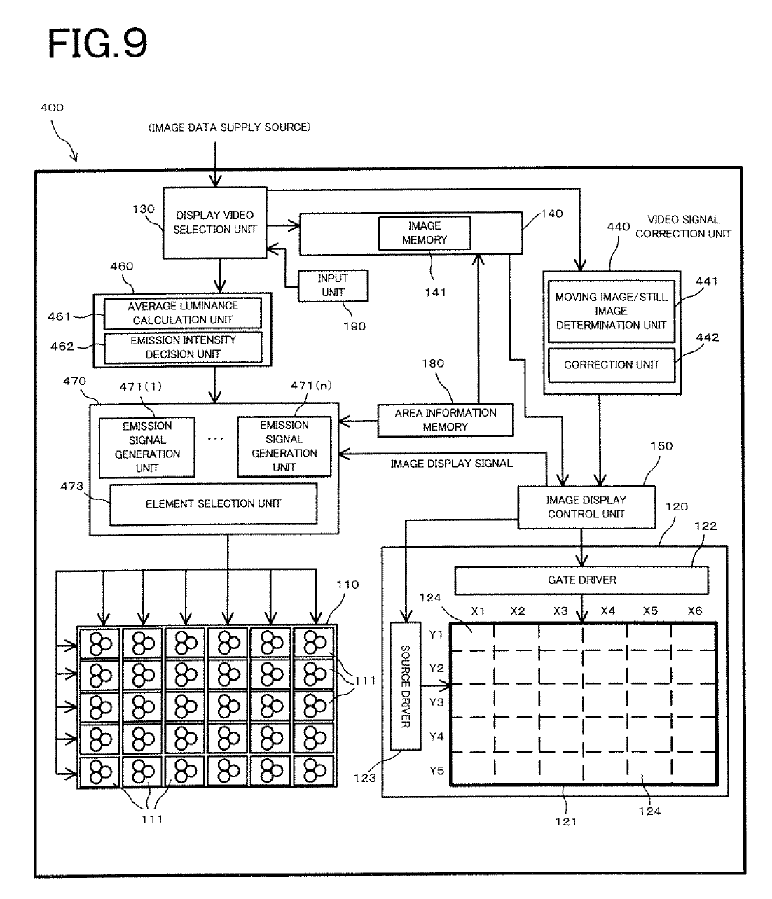

Hereinafter, a fourth embodiment of the present invention will be described in detail with reference to the drawing. FIG. 9 is a block diagram showing the structure of a liquid crystal display device 400 according to the fourth embodiment of the present invention. As shown in FIG. 9, the liquid crystal display device 400 includes a backlight unit 110, a display unit 120, a display video selection unit 130, a video signal synthesis unit 140, an image display control unit 150, a light source control instruction unit 460, a backlight control unit 470, an area information memory 180, an input unit 190, and a video signal correction unit 440.

The light source control instruction unit 460 has an average luminance calculation unit 461 and an emission intensity decision unit 462. The average luminance calculation unit 461 calculates an average luminance of each area 124 on a liquid crystal panel 121. The emission intensity decision unit 462 decides emission intensities of unit light sources 111 corresponding to the areas 124 respectively, based on the average luminances calculated by the average luminance calculation unit 461.

Here, when the calculated average luminance is lower than a predetermined reference luminance, the emission intensity is made lower than a reference emission intensity. In the second embodiment, when the calculated average luminance is lower than the predetermined reference luminance, the emission intensity is made higher than the reference emission intensity in order to prevent blackening. In this embodiment, on the other hand, the emission intensity of the unit light source 111 corresponding to the area 124 in a dark state is lowered, thereby increasing a contrast on the liquid crystal panel 121. As a result, in deciding whether to increase/decrease the emission intensity of the unit light source 111, the decision by the emission intensity decision unit 462 of this embodiment and the decision of the emission intensity decision unit 262 of the second embodiment are opposite to each other. For example, depending on whether the calculated luminance is higher or lower than the predetermined reference luminance, different coefficients are adopted (when the average luminance is higher than the reference: a large coefficient, when the average luminance is lower than the reference: a small coefficient), and the emission intensity decision unit 462 multiplies the average luminance by a correction value, thereby calculating the emission intensity.

The backlight control unit 470 has emission signal generation units 471(1) to 471(n) and an element selection unit 473. The emission signal generation units 471(1) to 471(n) correspond to the areas 124 respectively. The emission signal generation units 471(1) to 471(n) output control signals controlling emission intensities of the unit light sources 111 corresponding to the respective areas 124 on the liquid crystal panel 121, based on the decision by the emission intensity decision unit 462. The element selection unit 473 outputs the control signals generated by the emission signal generation units 471, to the unit light sources 111 corresponding to the respective areas 124.

The video signal correction unit 440 has a moving image/still image determination unit 441 and a correction unit 442. The moving image/still image determination unit 441 determines whether image data output from the display video selection unit 130 is a moving image or a still image, and the same structure as that of the moving image/still image determination unit 161 of the first embodiment can be adopted for the moving image/still image determination unit 441. The correction unit 442 corrects the image data which is determined as a still image by the moving image/still image determination unit 441 (for example, image data from a computer) so that the image data can be viewed on the first or second display area A1 or A2 with original brightness.

As described above, the emission intensity of each of the unit light sources 111 corresponding to the areas 124 is independently controlled, and when the average luminance of the area 124 on the liquid crystal panel 121 is low, the emission intensity of the corresponding unit light source 111 is lowered, thereby improving a contrast. When still images are displayed on the display areas A1, A2, luminances of the display areas A1, A2 lower, which may lower visibility all the more. To prevent such deterioration in visibility, luminance (transmittance) of the liquid crystal panel 121 is increased, thereby compensating for the decrease in emission intensity of the unit light sources 111. By keeping a transmittance T of the liquid crystal panel 121 and an emission intensity P of the backlight unit 110 well balanced, a brightness B on the liquid crystal panel 121 is controlled to become equal to an original brightness B0. Specifically, if a relation of P=P0*k holds, where P is the emission intensity decided by the emission intensity decision unit 462 and P0 is the original emission intensity, the transmittance T after the correction can be calculated by T=T0/k, where T0 is a transmittance before the correction.

### Fifth Embodiment

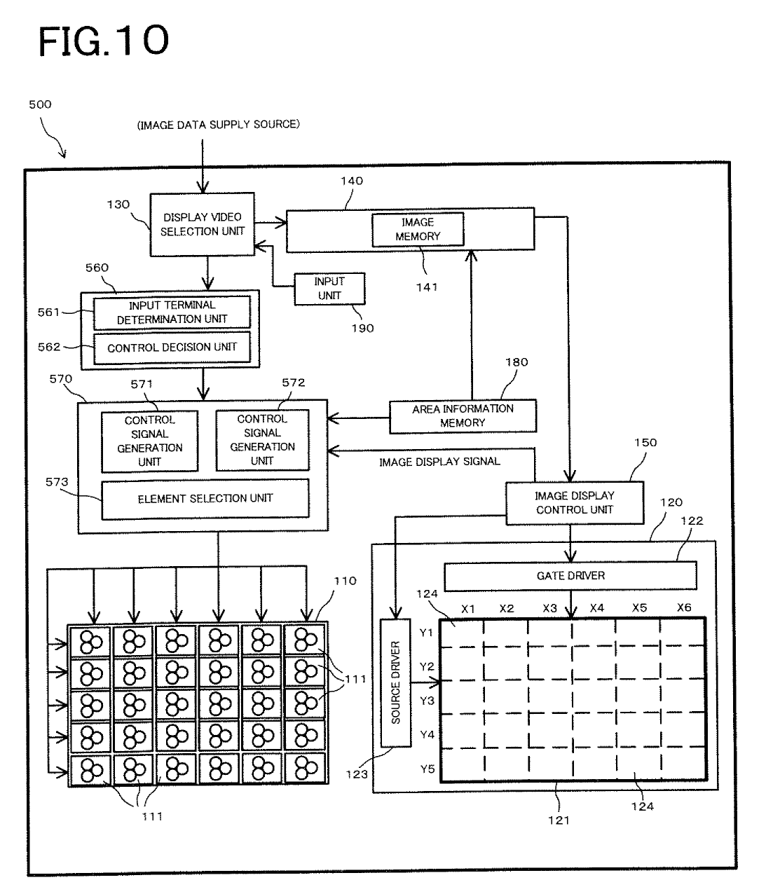

Hereinafter, a fifth embodiment of the present invention will be described in detail with reference to the drawing. FIG. 10 is a block diagram showing the structure of a liquid crystal display device 500 according to the fifth embodiment of the present invention. As shown in FIG. 10, the liquid crystal display device 500 includes a backlight unit 110, a display unit 120, a display video selection unit 130, a video signal synthesis unit 140, an image display control unit 150, a light source control instruction unit 560, a backlight control unit 570, an area information memory 180, and an input unit 190.

The light source control instruction unit 560 has an input terminal determination unit 561 and a control decision unit 562. The input terminal determination unit 561 determines which terminal has received image data output from the display video selection unit 130. When there is a correspondence relation between terminals and the types of image data input through these terminals, by determining which of the terminals has received the image data, it is possible to decide the type of an image, and as a result, to decide how the backlight unit 110 should be controlled. It is possible to discriminate the type of each image data by, for example, assigning identification information (unique ID or the like) to each terminal of an external interface.

The backlight control unit 570 has control signal generation units 517, 572 and an element selection unit 573. The control signal generation units 571, 572 output control signals Si controlling emission intensities of unit light sources 111 corresponding to the respective display areas Ai, based on the decision by the control decision unit 562. The element selection unit 573 outputs the control signals Si to the unit light sources 111 corresponding to the respective display areas Ai stored in the area information memory 180.

### Other Embodiments

The above-described embodiments are not intended to limit the present invention and can be extended and modified. The extended and modified embodiments are also included in the technical scope of the present invention.

What is claimed is:

1. A display device, comprising:
a display unit having a first and a second display area displaying a first and a second image corresponding to first and second image data;
a light source unit disposed so as to correspond to the display unit and having a plurality of unit light-emitting areas which are independently controllable;
a selection unit selecting, from the plural unit light-emitting areas, a first and a second unit light-emitting area corresponding to the first and second display areas respectively; and
a control signal generation unit generating a first and a second control signal controlling the selected first and second unit light-emitting areas, based on the first and second image data.

2. The display device according to claim 1,
wherein the display unit has a first to a third display area displaying a first to a third image corresponding to first to third image data respectively;
wherein the selection unit selects, from the plural unit light-emitting areas, a first to a third unit light-emitting area corresponding to the first to third display areas respectively; and
wherein the control signal generation unit generates a first to a third control signal controlling the selected first to third unit light-emitting areas, based on the first to third image data.

3. The display device according to claim 1, further comprising
a moving image/still image determination unit determining whether each of the first and second images is a moving image or a still image,
wherein the control signal generation unit generates the first and second control signals based on results of the determination.

4. The display device according to claim 3, wherein the moving image/still image determination unit determines whether each of the first and second images is a moving image or a still image, based on whether or not each of the first and second image data includes data of a motion vector.

5. The display device according to claim 3, wherein the moving image/still image determination unit determines whether each of the first and second images is a moving image or a still image, based on which terminal has received each of the first and second image data.

6. The display device according to claim 1, further comprising
an emission intensity decision unit which decides emission intensities of the plural unit light-emitting areas, based on average luminances of a plurality of areas which are disposed in the first and second display areas and each of which corresponds to one of the plural unit light-emitting areas,
wherein the selection unit selects, from the plural unit light-emitting areas, a plurality of unit light-emitting areas corresponding to the plural areas; and
wherein the control signal generation unit generates a plurality of control signals controlling the plural selected unit light-emitting areas, based on results of the decision.

7. The display device according to claim 6, wherein the emission intensity decision unit decides the emission intensities so as to lower the emission intensity of the unit light-emitting area corresponding to the area whose average luminance is lower than a reference value, and so as to increase the emission intensity of the unit light-emitting area corresponding to the area whose average luminance is higher than the reference value.

8. The display device according to claim 7, further comprising
an image data correction unit which, when the first and second images are determined as still images, corrects the first and second image data so as to increase a luminance of the area whose average luminance is lower than the reference value and so as to decrease a luminance of the area whose average luminance is higher than the reference value.

9. An image display method in a display device which comprises: a display unit having a first and a second display area displaying a first and a second image corresponding to first and second image data respectively; and a light source unit disposed so as to correspond to the display unit and having a plurality of unit light-emitting areas which are independently controllable, the method comprising:
selecting, from the plural unit light-emitting areas, a first and a second unit light-emitting area corresponding to the first and second display areas respectively; and
generating a first and a second control signal controlling the selected first and second unit light-emitting areas, based on the first and second image data.

10. The image display method according to claim 9,
wherein the display unit has a first to a third display area displaying a first to a third image corresponding to first to third image data respectively;
wherein the selecting includes selecting, from the plural unit light-emitting areas, a first to a third unit light-emitting area corresponding to the first to third display areas respectively; and
wherein the generating includes generating a first to a third control signal controlling the selected first to third unit light-emitting areas, based on the first to third image data.

11. The image display method according to claim 9, further comprising
determining whether each of the first and second images is a moving image or a still image,
wherein the generating includes generating the first and second control signals based on results of the determination.

12. The image display method according to claim 11, wherein the determining includes determining whether each of the first and second images is a moving image or a still image, based on whether or not each of the first and second image data includes data of a motion vector.

13. The image display method according to claim 11, wherein the determining includes determining whether each of the first and second images is a moving image or a still image, based on which terminal has received each of the first and second image data.

14. The image display method according to claim 9, further comprising
deciding emission intensities of the plural unit light-emitting areas, based on average luminances of a plurality of areas which are disposed in the first and second display areas and each of which corresponds to one of the plural unit light-emitting areas,
wherein the selecting includes selecting, from the plural unit light-emitting areas, a plurality of unit light-emitting areas corresponding to the plural areas; and
wherein the generating includes generating a plurality of control signals controlling the plural selected unit light-emitting areas, based on results of the decision.

15. The image display method according to claim 14, wherein the deciding includes deciding the emission intensities so as to lower the emission intensity of the unit light-emitting area corresponding to the area whose average luminance is lower than a reference value, and so as to increase the emission intensity of the unit light-emitting area corresponding to the area whose average luminance is higher than the reference value.

16. The image display method according to claim 15, further comprising
when the first and second images are determined as still images, correcting the first and second image data so as to increase a luminance of the area whose average luminance is lower than the reference value and so as to decrease a luminance of the area whose average luminance is higher than the reference value.
